(19) United States
(12) Patent Application Publication
(10) Pub. No.: US 2025/0321528 A1
(43) Pub. Date: Oct. 16, 2025

(54) APPARATUS MANAGEMENT SYSTEM, IMAGE FORMING APPARATUS, AND INFORMATION PROCESSING APPARATUS

(71) Applicant: CANON KABUSHIKI KAISHA, Tokyo (JP)

(72) Inventors: MASATOSHI YOSHIDA, Shizuoka (JP); MASATO SUZUKI, Shizuoka (JP); TAKEHITO OSADA, Shizuoka (JP); TAKASHI KUWATA, Shizuoka (JP)

(21) Appl. No.: 19/169,612

(22) Filed: Apr. 3, 2025

(30) Foreign Application Priority Data
Apr. 16, 2024 (JP) 2024-066108

(51) Int. Cl. G03G 15/00; G06F 3/12

(52) U.S. Cl. CPC G03G 15/55; G03G 15/5016; G03G 15/5079; G03G 15/70; G06F 3/121; G06F 3/1234; G06F 3/1288

(57) ABSTRACT

An apparatus management system for managing an image forming apparatus includes a detecting unit for detecting conveyance failure of a recording material the image forming apparatus; a cause discriminating unit for discriminating a cause of the conveyance failure on the basis of information acquired from the image forming apparatus; a display unit for displaying information on the cause discriminated by the cause discriminating unit; and a display discriminating unit for discriminating whether or not the information on the cause is displayed on the display unit. The display discriminating unit discriminates whether or not the information on the cause is displayed on the display unit, on the basis of a first occurrence rate which is a number of times of the conveyance failure occurred per unit time and a second occurrence rate which is a number of times of the conveyance failure per number of printed sheets.

### FIELD OF THE INVENTION AND RELATED ART

The present invention relates to an apparatus management system, an image forming apparatus, and an information processing apparatus.

Recently, in the market of the image forming apparatus represented by a laser printer, an opportunity such that a dealer concludes a maintenance contract or a meter-rate contrast (for example, contract such that a fee depending on the number of printed sheets is charged) increases. In such a contract form, a service cost is included in a print price, and therefore, suppression of unnecessary dispatch to a user's place and improvement in efficiency of trouble elimination are important. As one of methods of the improvement in efficiency of trouble elimination, there is a countermeasure (method) against a sheet conveyance trouble (hereinafter, referred to as a “jam”) by the dealer who performs maintenance management. In the case where the jam frequently occurred in the user's place, a cause of the jam ranges widely. For this reason, even in the case where the cause of the jam can be solved by remote indication, such as the case where the cause of the jam is due to usage of the user, the dealer who performs the maintenance management is forced to be dispatched to the user's place and has to investigate the cause by actually recognizing the jam unnecessary service dispatch occurred. In order to solve such a problem, a conventional technique enabling the user himself (herself) to address the problem in the case where the jam frequently occurred in the user's place, without that the dealer who performs the maintenance management is dispatched and addresses the problem is proposed, for example, in U.S. Pat. No. 11,479,427.

However, in the conventional technique, under a condition such that the number of jam occurrence sheets per the number of printed sheets becomes a predetermined threshold or more for each of sheet storages, whether or not a countermeasure (method) is notified at a display portion (unit) is determined. For this reason, for example, even when the number of jam occurrence sheets per (one) day is a predetermined number of sheets or more, even in the case where the jam occurred over a plurality of storages, the number of jam occurrence sheets does not exceed the threshold in some instances. In such a case, there is a problem such that the countermeasure cannot be notified to the user. The user has a tendency to feel dissatisfaction in the case where the number of times of the jam occurred during a day, so that when the user feels dissatisfaction, there is a liability that a service call occurs. When the service cell occurs, the dealer who performs the maintenance management is forced to be dispatched even in the case where the cause is the jam, thus leading to a problem such that a cost required for the dispatch of the dealer and a service cost are increased.

Further, in the conventional technique, in the case where there are plural countermeasures to be notified, all the possible countermeasures are notified. For that reason, although there is a possibility that the cause of the jam can be eliminated by carrying out all the notified countermeasures, there is a problem such that it takes time and effort until the user gets to a true cause of the jam.

### SUMMARY OF THE INVENTION

The present invention has been accomplished in view of the above-described circumstances.

A principal object of the present invention is to notify a user or a dealer who performs maintenance management of a countermeasure against a cause of a jam at an appropriate timing before a service cell occurs, by specifying a cause high in possibility for the jam occurred in an image forming apparatus.

According to an aspect of the present invention, there is provided an apparatus management system for managing an image forming apparatus, comprising: a detecting unit configured to detect conveyance failure of a recording material in the image forming apparatus; at least one cause discriminating unit configured to discriminate a cause of the conveyance failure, detected by the detecting unit, on the basis of information acquired from the image forming apparatus; a display unit configured to display information on the cause discriminated by the cause discriminating unit; and a display discriminating unit configured to discriminate whether or not the information on the cause is displayed on the display unit, wherein the display discriminating unit discriminating whether or not the information on the cause is displayed on the display unit, on the basis of a first occurrence rate which is a number of times of the conveyance failure occurred per unit time and a second occurrence rate which is a number of times of the conveyance failure per number of printed sheets.

According to another aspect of the present invention, there is provided an image forming apparatus for forming an image on a recording material, comprising: a detecting unit configured to detect conveyance failure of the recording material; at least one cause discriminating unit configured to discriminate a cause of the conveyance failure detected by the detecting unit; a display unit configured to display information on the cause discriminated by the cause discriminating unit; and a display discriminating unit configured to discriminate whether or not the information on the cause is displayed on the display unit, wherein the display discriminating unit discriminating whether or not the information on the cause is displayed on the display unit, on the basis of a first occurrence rate which is a number of times of the conveyance failure occurred per unit time and a second occurrence rate which is a number of times of the conveyance failure per number of printed sheets.

According to a further aspect of the present invention, there is provided an information processing apparatus capable of communicating with an image forming apparatus, comprising: a cause discriminating unit configured to discriminate a cause of conveyance failure in the image forming apparatus on the basis of information acquired from the image forming apparatus; and a display discriminating unit configured to discriminate whether or not information on the cause is displayed on a display unit, wherein the display discriminating unit discriminating whether or not the information on the cause is displayed on the display unit, on the basis of a first occurrence rate which is a number of times of the conveyance failure occurred per unit time and a second occurrence rate which is a number of times of the conveyance failure per number of printed sheets.

Further features of the present invention will become apparent from the following description of exemplary embodiments with reference to the attached drawings.

### BRIEF DESCRIPTION OF THE DRAWINGS

FIG. 1 is a schematic sectional view showing an image forming apparatus of embodiments 1 to 3.

Parts (a) to (d) of FIG. 2 are schematic views for illustrating a mechanism for causing a jam in the embodiments 1 to 3.

FIG. 3 is a flowchart showing a jam cause discrimination and display discrimination processing in the embodiments 1 and 2.

FIG. 4 is a graph in which an output of a media detecting device is subjected to arithmetic processing in the embodiments 1 to 3.

FIG. 5 is a flowchart showing jam cause discrimination or selection and display discrimination processing in the embodiments 1 and 2.

FIG. 6 is an illustration (block diagram) of an apparatus management system of the embodiments 1 to 3.

FIG. 7 is a flowchart showing one jam cause discrimination processing in the embodiment 2.

FIG. 8 is a flowchart showing selection processing of a jam cause high in possibility in the embodiment 2.

FIG. 9 is a flowchart showing jam cause discrimination and display discrimination processing in the embodiment 3.

### DESCRIPTION OF THE EMBODIMENTS

In the following, an image forming apparatus 100 according to the present invention and an external notifying system (apparatus management system) operating in communication with the image forming apparatus 100 will be described. Herein, as the image forming apparatus 100, a color laser printer (hereinafter, simply referred to as a printer) of an electrophotographic type will be described as an example with reference to the drawings. Incidentally, an embodiment of the present invention is applied to the printer, but the present invention is not limited thereto, and may also be applied to a copying machine, an ink jet printer, and the like.

### Outline of Image Forming Apparatus 100

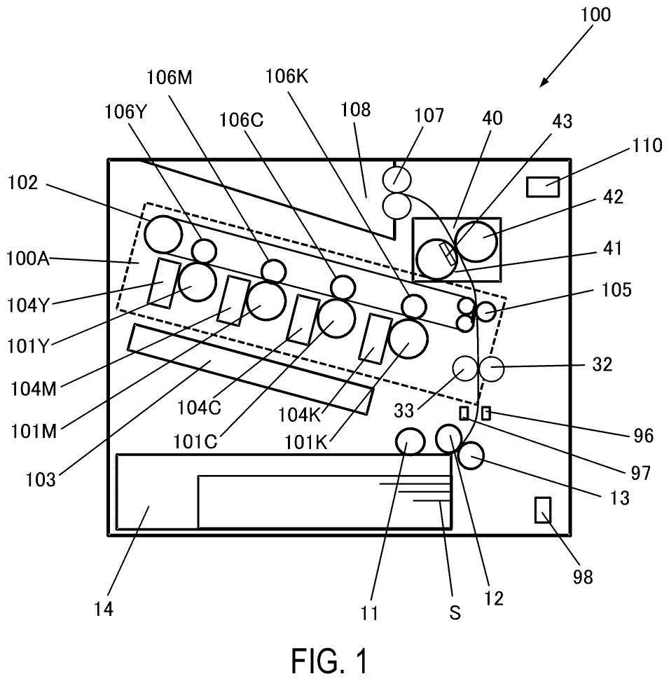

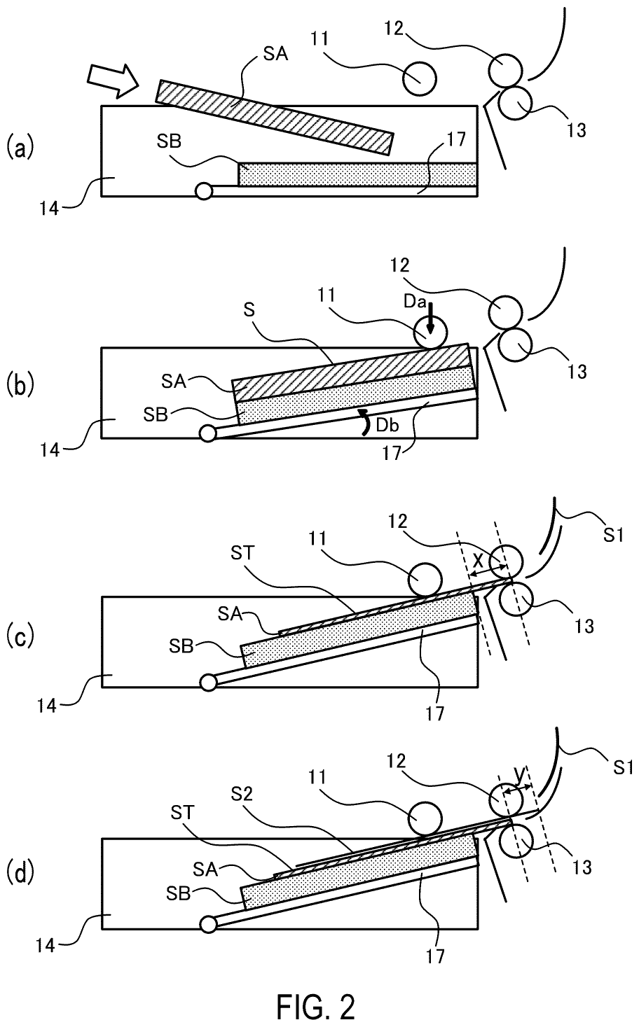

First, a schematic constitution of the image forming apparatus 100 will be described using FIG. 1. FIG. 1 is a schematic sectional view of a printer according to embodiments of the present invention. The image forming apparatus 100 is an apparatus for forming an image by the electrophotographic type and is provided with, as image forming units (image forming portions or means), four photosensitive drums 101Y, 101M, 101C, and 101K for forming toner images of four colors of yellow, magenta, cyan, and black, respectively. Incidentally, as regards suffixes Y, M, C, and K representing the four colors, these suffixes are omitted in some instances except for the case where a member of a specific color is described. Further, the image forming portion of the image forming apparatus 100 includes an intermediary transfer belt 102, a primary transfer roller 106, and a secondary transfer roller 105.

The intermediary transfer belt 102 is an endless belt which contacts the four photosensitive drums 101 and onto which the toner images formed on the four photosensitive drums 101, respectively, are transferred. The primary transfer roller 106 forms a nip with the photosensitive drum 101 from an inner peripheral surface side of the intermediary transfer belt 102 and generates a potential difference between the photosensitive drum 101 and the intermediary transfer belt 102, so that the toner image is transferred onto the intermediary transfer belt 102 (primary transfer). The secondary transfer roller 105 forms a nip (secondary transfer portion) with an outer peripheral surface side of the intermediary transfer belt 102, and transfers the image, transferred on the intermediary transfer belt 102, onto a sheet S as a recording material (secondary transfer).

When an image forming operation is started in the image forming apparatus 100, the photosensitive drum 101 charged to a certain potential is irradiated with light depending on an image signal by a laser scanner 103, so that an electrostatic latent image is formed on the photosensitive drum 101. Then, the electrostatic latent image is developed with toner accommodated in a developing cartridge 104, so that a toner image (visible image) is formed on the photosensitive drum 101. The toner image formed on the photosensitive drum 101 is subsequently primarily transferred onto the intermediary transfer belt 102, and the toner image transferred on the intermediary transfer belt 102 is conveyed toward the secondary transfer portion by the intermediary transfer belt 102.

In parallel to such an image forming operation, sheets S are fed one by one from an accommodating portion 14 for the sheets S. This sheet S is conveyed to the secondary transfer portion, formed by the nip between the intermediary transfer belt 102 and the secondary transfer roller 105, by a registration roller pair 32 and 33 for correcting sheet skew. Here, there is a need that the sheet S is positionally aligned with the toner image, formed on the intermediary transfer belt 102, with respect to a conveying direction of the sheet S, and therefore, timing matching of the sheet S is performed by carrying out conveying speed control of the registration roller 32. Then, by applying a voltage to the secondary transfer roller 105 in the secondary transfer portion, the toner image is transferred from the intermediary transfer belt 102 onto the sheet S. The sheet S on which the toner image is transferred is then conveyed to a fixing device 40 and is heated and pressed in the fixing device 40, so that the toner image is fixed on the sheet S. The fixing device 40 includes a fixing film 41, a pressing roller 42, and a heater 43. After the fixing, the sheet S is discharged by a discharging roller pair 107 onto a discharge portion 108 at an upper portion of the image forming apparatus 100. On a conveying path along which the sheet S is conveyed, a plurality of conveying rollers which are not shown in FIG. 1 are also provided, and these conveying rollers, a feed roller 12, the registration roller 32, and the discharging roller pair 107 function as conveying means for conveying the sheet S.

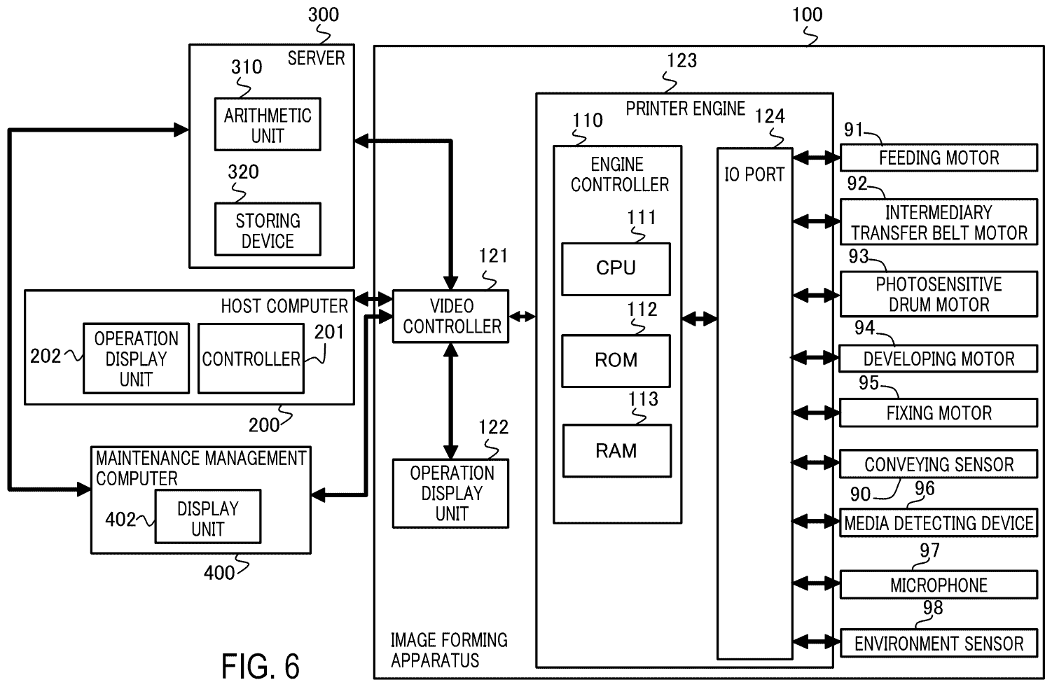

The image forming apparatus 100 includes an engine controller 110. As shown in FIG. 6 described later, the engine controller 110 includes a CPU 111, a ROM 112, and a RAM 113. The CPU 111 controls the image forming apparatus 100 in accordance with a program stored in the ROM 112 while using the RAM 113 as a temporary working area. In the ROM, various parameters are also stored.

With respect to the conveying direction of the sheet S, a media detecting device 96 and a microphone 97 as a sound collecting means are provided on a side upstream of the registration roller 32. The media detecting device 96 and the microphone 97 are disposed so as to sandwich the conveying path. The media detecting device 96 detects physical characteristics such as a basis weight and a surface property of the conveyed sheet S. The microphone 97 collects an operation sound or the like generated in the image forming apparatus 100 and converts the operation sound into an electric signal, and then sends the electric signal to the engine controller 110. Incidentally, a constitution in which occurrence of conveyance failure such as double (multi) feeding is discriminated by using the media detecting device 96 as a transmitting portion and by using the microphone 97 as a receiving portion may be employed. For example, an ultrasonic wave is transmitted from the media detecting device 96 as the transmitting portion and is received by the microphone 97 as the receiving portion. The microphone 97 receives the ultrasonic wave through the recording material (recording paper) S when the recording material S conveyed along the conveying path is present. On the basis of a receiving result by the microphone 97, a CPU 111 described later can also discriminate whether or not double feeding occurs in a sheet (paper) feeding portion, for example. The image forming apparatus 100 includes an environment sensor 98 as an environment detecting means for detecting a temperature and a humidity in the image forming apparatus 100. Incidentally, a pick-up roller 11, the feed roller 12, and a separation roller 13 in FIG. 1 will be described later.

### Apparatus Management System

Next, an apparatus management system including the image forming apparatus 100 to which the embodiment 1 is applied and a server or the like operating in communication with the image forming apparatus 100 will be described using FIGS. 2 to 6. There are various causes for a jam occurring in the image forming apparatus 100, and an occurrence cause is specified for each jam and information based on the cause is notified, so that the jam can be eliminated (cleared). As a method of specifying the cause of the jam, various methods have been proposed. In the embodiment 1, as an example thereof, a display discriminating means for the information based on the surface of the jam, which is a feature of the present invention will be described by using specification of the jam due to a difference in kind of sheets stacked in the accommodating portion 14.

### Mechanism for Occurrence of Jam in Case of Mixed Loading of Sheets in Accommodating Portion 14

First, an operation in which sheets different in kind are loaded in mixture in the accommodating portion 14 and then are fed will be described. Parts (a) to (d) of FIG. 2 are schematic sectional views each showing the accommodating portion 14 and a neighborhood of a sheet (paper) feeding portion. Part (a) of FIG. 2 shows a state in which the sheets are being loaded in mixture and accommodated in the accommodating portion 14, and part (b) of FIG. 2 shows a state immediately before a start of sheet feeding. Part (c) of FIG. 2 shows a state during the sheet feeding, and part (d) of FIG. 2 shows a state immediately before occurrence of the jam after the sheet is further fed from the state of part (c) of FIG. 2.

As shown in part (a) of FIG. 12, in the embodiment 1, the sheets are loaded in mixture and stacked in the accommodating portion 14, and then are fed. In part (a) of FIG. 2, a state in which sheets S consisting of sheets SA (for example, plain paper 1) and sheets SB (for example, plain paper 2) stacked on the sheets SA are stacked by a user on a several tens of sheets-basis is shown. Thus, a state in which the sheets SA and SB different in kind are present in the same accommodating portion 14 is referred to as “mixed loading (state)”.

Here, the sheet SA and the sheet SB will be described. As regards two kinds of the sheets, a temperature at which the toner is fixed by the fixing device 40 of the image forming apparatus 100 is used in an operation in the same fixing temperature control mode set for the plain paper, and these sheets are classified into the same category of “plain paper” in that sense. However, detailed physical property values such as a basis weight and a surface property of the sheets are different from each other, and in this sense, the kind of the sheet SA and the kind of the sheet SB are different from each other. In order to show this difference numerals 1 and 2 are added to the plain paper, as “plain paper 1” and “plain paper 2”. The basis weight of the sheet is a weight per unit area of the sheet and is represented by [g/cm²].

Next, a processing up to an operation immediately before a start of the sheet feeding will be described using part (b) of FIG. 2. When the image forming apparatus 100 starts a print operation, first the pick-up roller 11 lowers in an arrow Da direction shown in part (b) of FIG. 2. Thereafter, a lift-up plate 17 is rotated in an arrow Db direction shown in part (b) of FIG. 2, and lifts up (raises) the sheets Sa and the sheets SB, so that the sheets A contact the pick-up roller 11. By this, a sheet feeding position is determined, so that an operation of the lift-up plate 17 is stopped.

Thereafter, the sheet S (sheet SA) stacked at an uppermost surface of the accommodating portion 14 is started to be subjected to a pick-up operation by the pick-up roller 11 and is conveyed to the feed roller 12, and then is conveyed to the image forming portion. Here, in the case where a friction coefficient μ between the sheet SA and the sheet SB is small, the sheets SA are fed by the number of sheets to some extent, and when the number of remaining sheets SA becomes about 10 sheets, the following phenomenon occurs. Due to the small friction coefficient μ between the sheet SA and the sheet SB, all the sheets SA of about 10 sheets are conveyed to a nip between the feed roller 12 and the separation roller 13 by a conveying force of the pick-up roller 11, so that a sheet bundle St of about 10 sheets is integrally taken out. The sheet bundle ST shows a bundle of sheets of about 10 sheets. This state is shown in part (c) of FIG. 2. That is, a state in which all the remaining sheet SA are conveyed and taken out by a distance x from a sheet leading end of the sheets SB stacked in the accommodating portion 14 to the nip between the feed roller 12 and the separation roller 13 is formed.

In this state, by a thickness of the sheet bundle ST, the nip formed by the feed roller 12 and the separation roller 13 is released. When the sheets S are continuously fed in that state, the separation roller 13 cannot perform an original function such that the separation roller 13 separates and handles the sheets one by one. For this reason, a sheet S2 fed subsequently to a sheet S1 is taken out, so that a leading end of the sheet S2 stops at a position in some instances where the leading end of the sheet S2 advances by y from a nip position formed by the feed roller 12 and the separation roller 13. Incidentally, the position where the leading end of the sheet S2 advances by y is a position downstream of the nip position by y with respect to the conveying direction. This state is shown in part (d) of FIG. 2.

When a pick-up operation is started from this state, a sheet interval defined by a trailing end of the sheet S1 and the leading end of the subsequent sheet S2 is decreased (narrowed) by y which is not intended in design. As a result, the sheet interval between the sheet (paper) and the subsequent sheet (paper) becomes an allowable level or less, and therefore, the image forming apparatus 100 discriminates that it is hard to perform an image forming process, and stops a print operation and then notifies that a jam (paper jam) occurred.

As described above, when the sheets are loaded in mixture (mixed loading) in the accommodating portion 14 and then are fed, in the case where a friction coefficient μ between the sheets different in kind is small, there is a possibility that the jam occurs.

### Flow for Discriminating Cause of Jam From Information Acquired From Image Forming Apparatus 100 by Cause Discriminating Unit (Portion)

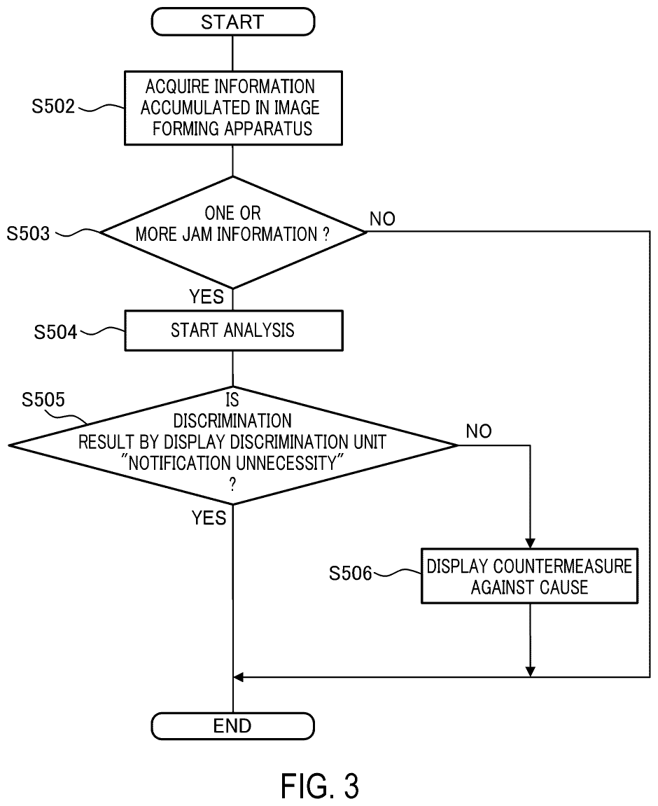

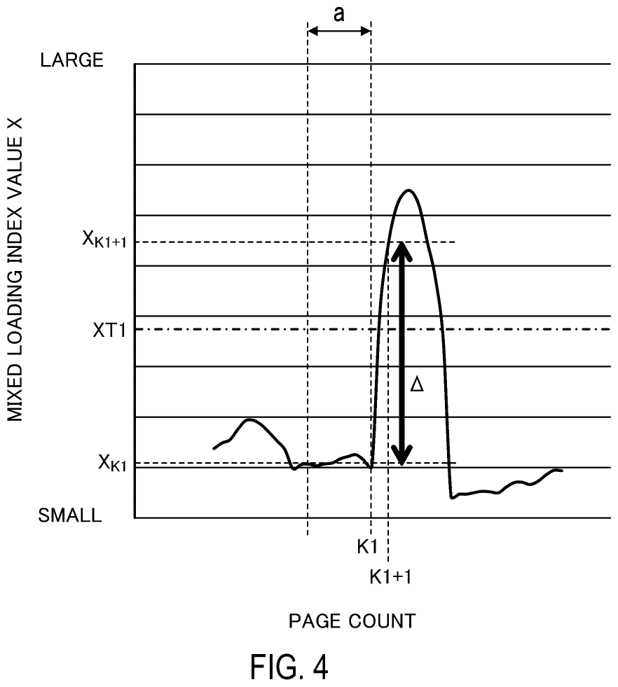

In the embodiment 1, a cause discriminating unit (portion) as a cause detecting means discriminates in analysis of a step (hereinafter, referred to as “S”) 504 shown in FIG. 3 that the cause of the jam is the mixed loading. For the discrimination, a mixed loading index value is used, and in the case where the mixed loading index value exceeds a certain threshold, the cause discriminating unit discriminates that the cause of the jam is the mixed loading, but a flow of this discrimination will be described also using FIG. 4. Incidentally, a specific constitution functioning as the cause discriminating unit will be described later with reference to FIG. 6.

In the embodiment 1, in the case where the jam occurred, processing shown in FIG. 3 is started every time.

Thereafter, in S504 of FIG. 3, each of jams which occurred, cause analysis of the jam is conducted by the cause discriminating unit. The cause of the jam includes a cause which can be specified by the analysis and a cause which cannot be specified even by the analysis. In the embodiment 1, as the cause of the jam, only the mixed loading is the cause which can be specified by the analysis.

When the jam occurred and the processing of FIG. 3 is started, in S502, the cause discriminating unit acquires information accumulated in the image forming apparatus 100. In S503, the cause discriminating unit discriminates whether or not jam information is one or more. In S503, in the case where the cause discriminating unit discriminated that there is no jam information, the processing is ended, and in the case where the cause discriminating unit discriminated that the jam information is one or more, the cause discriminating unit causes the processing to go to S504. In S504, the cause discriminating unit starts the analysis of the jam. In S505, the cause discriminating unit discriminates whether or not notification is unnecessary on the basis of a result of the analysis in S504. In S505, in the case where the cause discriminating unit discriminated that the notification is necessary, the cause discriminating unit causes the processing to go to S506, and in S506, the cause discriminating unit causes a display unit (portion) 402 (see FIG. 6) to display a countermeasure (method) against the cause, and then ends the processing. Here, the countermeasure against the cause is a method for addressing the cause of the jam and is a method for eliminating a factor constituting the cause of the jam. For example, the mixed loading is the cause of the jam, a method in which sheets S are stacked so as to avoid the mixed loading, i.e., in which sheets S of only one kind are stacked in the accommodating portion 14 is the countermeasure method.

In S505, in the case where the cause discriminating unit discriminated that the notification is unnecessary, the cause discriminating unit ends the processing without causing the display unit 402 to display the information. Each of processes of the processing will be specifically described below.

In S502, the cause discriminating unit acquires data, from the image forming apparatus 100, necessary for calculating the above-described mixed loading index value. Specifically, the cause discriminating unit acquires a basis weight data for each of the sheets S subjected to printing, by the media detecting device 96 provided in the neighborhood of the registration roller 32. The cause discriminating unit calculates a moving average of a dispersion value of a predetermined number of sheets by using the acquired data (for example, the basis weight data). Here, the moving average calculated on the basis of the basis weight data is defined as a mixed loading index value X. Similarly, the cause discriminating unit also acquires a surface property data for each of the sheets S subjected to the printing by the media detecting device 96, and calculates the moving average of the dispersion value of the predetermined number of sheets by using the surface property data. Here, the moving average calculated on the basis of the surface property data is defined as a mixed loading index value Y. Incidentally, in FIG. 3, data acquired by detecting the sheet S by the media detecting device 96 as used, but the present invention is not limited thereto. For example, the mixed loading index value X and the mixed loading index value Y may be acquired on the basis of data of the sheet S inputted by a user through an operation display unit (portion) 122 described later, and a table which is stored in the ROM 112 in advance and in which the sheet S, the basis weight data, the surface property data, and the like are associated with each other.

When the sheets S of two kinds are loaded in mixture in a single accommodating portion 14, a physical property value of the sheet S of one kind is shifted to a physical property value with a mixed loading boundary as a boundary. Therefore, by acquiring the moving average as the mixed loading index value, at least either one of the mixed loading index value X and the mixed loading index value Y temporarily changed largely. In the embodiment 1, sheets of two kinds different in basis weight of the sheets were loaded in mixture, and transition of the mixed loading index value X at this time is shown in FIG. 4. Here, in FIG. 4, the abscissa represents a page count (the number of sheets), and the ordinate represents the mixed loading index value X.

The cause discriminating unit discriminates that a state of the sheets is the mixed loading state on the basis of a change amount of the mixed loading index value X. In order to divide discrimination as to whether or not the sheet state is the mixed loading state in the embodiment 1, the following definitions are provided. A fixed threshold is defined as XT1, a page count of a mixed loading boundary is defined as K1, a mixed loading index value X in the page count K1 of the mixed loading boundary is defined as X_{K1}, and a difference from the mixed loading index value X of the preceding sheet, i.e., a change amount is defined as Δ. In the case where the change amount Δ of the mixed loading index value X exceeds the threshold XT1 (XT1<Δ=X_{K1+1}−X_{K1}), the cause discriminating unit discriminates that the sheets are in the mixed loading state with the page count K1 as the mixed loading boundary. Incidentally, X_{K1+1} is the mixed loading index value in the page count K1+1 subsequent to the page count K1. In the case of FIG. 4, the sheets up to the page count K1 correspond to the sheets SA in FIG. 2, and the sheets from the page count K1+1 correspond to the sheets SB in FIG. 2. Incidentally, the threshold (XT1) of the mixed loading index value X and a threshold of the mixed loading index value Y may only be required to be determined on the basis of a value, which is a higher in variation, of physical property values of the sheets SA and SB. For example, the threshold may only be required to be set to a value of two or three times the variation, or the like value.

Thereafter, in the case where the sheet state is discriminated as the mixed loading state by the cause discriminating unit, a section a in which there is a possibility that the jam occurs due to the mixed loading is set as a value in a range of preceding 10 sheets including the page count K1, i.e., (K1-10)≤a≤K1. Incidentally, in the embodiment 1, the section a was set as the value in the range of preceding 10 sheets, but is not limited thereto. As described above with reference to part (b) of FIG. 2, the number of sheets of the sheet bundle ST taken out to the nip between the feed roller 12 and the separation roller 13 varies depending on the kind of the sheets S. For this reason, this setting of 10 sheets is not limited to the above-described setting. For example, a value corresponding to the 10 sheets may be changed depending on the kind of the sheets S. Thereafter, in the case where the jam occurred in the section a in which there is a possibility that the jam occurs, the cause discriminating unit discriminates that the cause of the jam is the mixed loading.

Incidentally, the analysis of S504 of FIG. 3 is conducted in the case where discrimination that there is one or more jam information, i.e., in the case where conveyance failure of the sheet S occurs one time or more, as shown in S503. Here, the conveyance failure of the sheet S includes, for example, a misprint in which a sheet is discharged in a blank state without that the image forming operation is not in time.

### Flow for Discriminating Whether or Not Information Based on Cause is Displayed on Display Unit

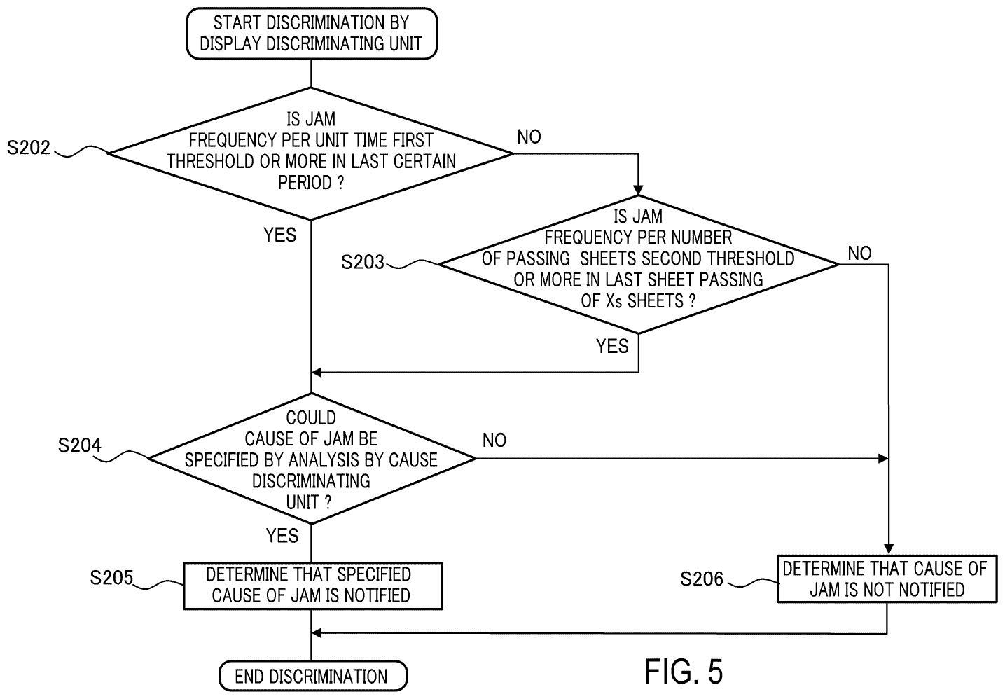

Details of a discrimination flow by a display discriminating unit as a display discriminating means in S505 shown in FIG. 3 will be described using FIG. 5. Incidentally, a specific constitution functioning as the display discriminating unit will be described later with reference to FIG. 6. When display discriminating processing is started, in S202, the display discriminating unit discriminates whether or not a jam frequency per unit time (first occurrence rate) is a first threshold or more in the last certain period. That is, the display discriminating unit calculates the number (of times) of jams occurred from the time of the last discrimination to the time of present discrimination, and discriminates whether or not the calculated number of the jams is a certain number (first threshold) per unit time or more.

In the embodiment 1, setting is made under a condition that the unit time is one day and the first threshold of the number of the jams is three times. The reason why the discrimination is made based on the occurrence rate per unit time is because there is a tendency that whether or not the user feels dissatisfaction with the jam and makes a service call is determined not only by the number of times of the occurrence of the jam per number of sheets subjected to printing by the image forming apparatus 100 but also by the number of times of the occurrence of the jam per unit time. The display discriminating unit defines a jam occurrence rate on a time basis and discriminates whether or not the jam frequency per unit time is the first threshold or more. Incidentally, S202 can be rewarded as a step of discriminating whether or not the jam occurrence rate exceeds an allowable limit value per day of the user.

In S202, in the case where the display discriminating unit discriminated that the jam frequency per unit time is the first threshold or more, the display discriminating unit causes the processing to go to S204. In S204, the display discriminating unit discriminates whether or not the cause of the jam can be specified in the analyzing processing shown in S504 of FIG. 3. In S204, in the case where the display discriminating unit discriminated that the cause of the jam was able to be specified, the display discriminating unit causes the processing to go to S205. In S205, the display discriminating unit determines that the jam cause specified in S504 of FIG. 3 and a countermeasure based on the cause are notified to a maintenance management computer 400 described later by displaying a message to that effect on the display unit 402 of the maintenance management computer 400, and then ends the processing. In this flow, the display discriminating unit gets a discrimination result of “notification necessity”.

In S204, in the case where the display discriminating unit discriminated that the cause of the jam cannot be specified by the analysis shown in S504 of FIG. 3, the display discriminating unit causes the processing to go to S206. In S206, the display discriminating unit determines that the jam cause and the countermeasure based on the cause are not displayed, and ends the processing. In this flow, the display discriminating unit gets a discrimination result of “notification unnecessity”.

In S202, in the case where the display discriminating unit discriminated that the jam frequency is less than the first threshold, the display discriminating unit causes the processing to go to S203. In S203, the display discriminating unit discriminates whether or not a jam frequency (second occurrence rate) per number of printed sheets (per number of sheets subjected to sheet passing) is a second threshold or more in the last conveyance (sheet passing) of sheets S of Xs sheets. In the embodiment 1, the last Xs sheets is set as 500 sheets, and the number of times of the second threshold is set as one time. In S203, in the case where the display discriminating unit discriminated that the jam frequency is the second threshold or more, the display discriminating unit causes the processing to go to S204. That is, the display discriminating unit performs the processing similar to the processing in the case where in S202, the jam frequency per unit time was the first threshold or more. In S203, in the case where the jam frequency per number of sheets subjected to sheet passing is less than the second threshold, the display discriminating unit causes the processing to go to S206, and determines that the jam cause and the countermeasure based on the cause are not displayed, and then ends the processing. In this flow, the display discriminating unit gets a discrimination result of “notification unnecessity”.

Incidentally, the first threshold and the second threshold may be determined in the following manner. For example, a server 300 collects the number of times of the occurrence of the post service calls and makes the collected number of times of the occurrence of the past service calls into a database. The first threshold and the second threshold may be determined on the basis of the number of the service calls occurred in a predetermined period.

Thus, in the embodiment 1, the processing of S202 (discrimination based on the jam frequency per unit time) and the processing of S203 (discrimination based on the jam frequency per number of sheets subjected to the sheet passing) are provided. By this, whether or not the jam cause and the countermeasure based on the cause are notified can be discriminated in consideration of the number of times of the occurrence of the jam per number of printed sheets and the number of times of the occurrence of the jam per unit time. In other words, whether or not the jam cause and the countermeasure based on the cause are notified can be discriminated by not only considering the conventional jam occurrence rate but also discriminating whether or not the jam occurrence rate exceeds an allowable limit value per day of the user.

Incidentally, in the case where the number of printed sheets is extremely large, for example, images are printed on 5000 sheets per day and the jam occurs only once per day, the conditions of S202 and S203 are not satisfied. In such a situation, in the embodiment 1, the jam cause and the countermeasure based on the cause are not displayed. However, the occurrence of the jam once a day continues every day, and thus there is a liability that the continuous occurrence of the jam leads to the service call. In that case, for example, a time-basis condition such that notification to the display unit 402 is determined in the case where the jam occurred four times in three days is added. By this, even for a user using an extremely large number of sheets subjected to printing, before the user makes the service call, the cause of the jam is specified, so that it becomes possible to display the jam cause and the countermeasure based on the cause.

### Path Through Which Specified Cause of Jam is Notified to User or Dealer Who Performs Maintenance Management

Next, by using FIG. 6, a path through which the specified cause of the jam is notified to the user or the dealer who performs the maintenance management will be described. FIG. 6 is a block diagram of a failure diagnosis system or an image forming system as an apparatus management system including the image forming apparatus 100 of the embodiment 1. As shown in FIG. 6, a host computer 200 (computer), the image forming apparatus 100, the server 300 which is information processing apparatus, and the maintenance management computer 400 as a monitoring tool are constituted so as to be communicatable with each other via a network, for example. A controller 201 of the host computer 200 includes a CPU which is a processor, and performs various kinds of processing by executing a control program stored in an unshown storing device. An operation display unit (portion) 202 includes a display, a keyboard, a mouse, and the like, and provides an interface. For example, the controller 201 sends a print job including image data to the image forming apparatus 100 in response to a user operation to the operation display unit 202, thus causing the image forming apparatus 100 to form an image based on the image data.

A video controller 121 of the image forming apparatus 100 performs communication processing with the host computer 200, the server 300, and the maintenance management computer 400 managed by the dealer.

In the case where the video controller 121 receives the print job from the host computer 200, the video controller 121 controls image formation based on the print job by a printer engine 123. The operation display unit 122 includes an operation panel, operation buttons, and the like, thus providing a user interface. The printer engine 123 includes the engine controller 110 including the CPU 111 which is a processor, the ROM 112, and the RAM 113. The ROM 112 is a non-volatile memory for holding and storing a control program and various data. Incidentally, instead of the ROM 112, a rewritable non-volatile memory can be used. The RAM 113 is a volatile memory for storing temporary data. The CPU 111 executes the control program stored in the ROM 112, thus controlling a feeding motor 91, an intermediary transfer belt motor 92, a photosensitive drum motor 93, a developing (device) motor 94, a fixing (device) motor 95 via an IO port 124, so that an image is formed on the sheet S.

Incidentally, the feeding motor 91 is a driving source for the pick-up roller 11, the feed roller 12, and registration roller 32. The intermediary transfer belt motor 92 is a driving source for the intermediary transfer belt 102. The photosensitive drum motor 93 is a driving source for the photosensitive drums 101. The developing motor 94 is a driving source for a developing roller included in each of the developing cartridges 104. The fixing motor 95 is a driving source for the pressing roller 42 of a fixing unit 30. These driving sources function as driving means.

A conveying sensor 90 is provided on a conveying path of the sheet S fed from the accommodating portion 14. A detection result of the conveying sensor 90 is used in conveyance control of the sheet S, discrimination as to whether or not the jam as a base of jam information of FIG. 3 occurs, and the like. The engine controller 110 functions as a detecting means for detecting whether or not the jam occurs. The media detecting device 96, the microphone 97, and the environment sensor 98 are as described above.

An arithmetic unit 310 of the server 300 includes one or more processors (CPUs), and executes a control program stored in a storing device 320, thus performing various kinds of processing described below. The storing device 320 includes arbitrary volatile and non-volatile storing devices. The storing device 320 stores, in addition to the program executed by the arithmetic unit 310, data used in the various kinds of processing by the arithmetic unit 310. In the embodiment 1, the storing device 320 is a constituent element of the server 300, but a part or all of data described below as data stored in the storing device 320 may be stored in an external device to which the server 300 has access via the network.

As shown in FIG. 3, when analysis is started in the server 300, the server 300 communicates with the video controller 121, and conducts the analysis by acquiring information accumulated in the image forming apparatus 100 (S502). In the case where one or more jams occur from the time of the last analysis to the time of the present analysis (S503: YES), the analysis (S504) is started. Here, the reason why the analysis is not conducted when one or more jam do not occur is for suppressing an operation due to unnecessary analysis. After the analysis, in the case where discrimination that the information based on the cause of the jam is notified is made (S505: NO), the jam cause specified in S504 and the countermeasure based on the cause are displayed on and notified to the display unit 402 of the maintenance management computer 400 so as to enable reference thereto (S506). That is, the arithmetic unit 310 of the server 300 functions as the above-described cause discriminating unit and the display discriminating unit.

The maintenance management computer 400 receives information on the cause of the jam and the countermeasure from the apparatus. By this, an inappropriate state eliminating method of the apparatus is instructed from a remote place to the user, a periodical exchange unit is supplied for a consumed one, and repair of a failure part can be made by dispatch of a service person to a user's place.

Incidentally, contents displayed on and notified to the display unit 402 may only be the cause of the jam, for example, in the embodiment 1, information such that “a possibility that a jam occurs due to mixed loading is high”. Further, the contents may only be the countermeasure, for example in the embodiment 1, information such that “sheets all of the same kind are recommended to be in a sheet accommodating portion”. Further, the contents may be both the jam cause and the countermeasure, for example in the embodiment 1, information such as “a possibility that a jam occurs due to mixed loading and therefore sheets all of the same kind are recommended to be stacked in a sheet accommodating portion”.

As described above, by the embodiment 1, it becomes possible that the cause with high possibility is specified when the jam or the like occurred in the image forming apparatus 100, and then the countermeasure can be notified to the dealer performing the maintenance management at an appropriate timing immediately before the user makes the service call. In the case where the specified cause is the mixed loading caused by the user's operation, the dealer performing the maintenance management provides an instruction to the user so as to eliminate the mixed loading state by a remote instruction such as telephone without performing the service dispatch, so that the dealer is capable of causing the user to eliminate the cause of the jam. The service dispatch of the dealer performing the maintenance management can be suppressed, so that it becomes possible to remarkably suppress a service cost.

Further, discrimination is made by using the display discriminating unit, whereby for every jam which does not occur frequently, the jam cause and the countermeasure are not notified to the user or the dealer performing the maintenance management, so that it is possible to prevent the user or the dealer performing the maintenance management from feeling troublesomeness. Incidentally, in the embodiment 1, high-level statistical processing is performed, and therefore, the jam cause specification by the cause discriminating unit was made on the server 300, and the discrimination as to whether or not the information based on the cause by the display discriminating unit is notified was also made on the server 300. However, these cause specification discrimination may also be made by the video controller 121 or the CPU 111.

Incidentally, in S502 of FIG. 3, the information acquired from the image forming apparatus 100 includes either one or more pieces of information consisting of conveyance information of the sheet S, output information of each motor, sound information, operation information of each unit, temperature/humidity environment information, and print information. The analysis of the cause is conducted on the basis of these pieces of information, so that the arithmetic unit 310 of the server 300 can also specify the control other than the mixed loading.

The conveyance information is, for example, timing information or the like based on a detection result of the conveying sensor 90 provided on the conveying path of the sheet S and for detecting a leading end and a trailing end of the sheet S. On the basis of the detection result of the conveying sensor 90, the engine controller 110 discriminates that the jam occurred in the case where the sheet S reaches a detecting position layer than an assumed timing or does not reach the detecting position at the assumed timing. Further, on the basis of the timing information, the arithmetic unit 310 of the server 300 is capable of discriminating the cause of the jam such as that a position of a trailing end regulating plate included in the accommodating portion 14 does not coincide with a position suitable for the sheet S.

The output information of each motor is, for example, torque information or the like of each motor. The image forming apparatus 100 includes the respective motors as described above with reference to FIG. 6 and acquires torque information of each motor.

The arithmetic unit 310 of the server 300 is capable of discriminating the cause of the jam such as that a predetermined roller is not provided or the like, on the basis of the torque information acquired from the image forming apparatus 100.

The sound information is information collected by the microphone 97. The arithmetic unit 310 of the server 300 is capable of specifying as to, for example, whether or not noise is generated in which unit, on the basis of the sound information, so that the arithmetic unit 310 is capable of discriminating the cause of the jam due to abnormality of the unit.

The operation information of each unit is, for example, information on opening/closing of a door provided to the image forming apparatus 100 and is information based on a detection result of a sensor for detecting the door. Further, for example, the operation information is information on insertion/pulling-off of the developing cartridge 104 detachably mountable to the image forming apparatus 100 and is information or the like based on a detection result of a sensor for detecting the insertion/pulling-off of the developing cartridge 104. The arithmetic unit 310 of the server 300 is capable of auxiliary using these pieces of information for discriminating the cause of the jam. The temperature/humidity environment information is information or the like based on a detection result of the environment sensor 98. The arithmetic unit 310 of the server 300 is capable of discriminating the jam, for example, due to curl of the sheet S absorbed moisture. The print information is information such as a print ratio sent to the image forming apparatus 100 when the user performs the print operation.

The arithmetic unit 310 of the server 300 is capable of discriminating the due to, for example, that the sheet S is curled depending on a difference in print ratio after the fixing processing is performed by the fixing device 40.

Incidentally, the arithmetic unit 310 of the server 300 accumulates the information from the image forming apparatus 100, and may cause the display unit 402 to display the cause of the jam and/or the countermeasure for eliminating the cause, for example, once a day or in real time. When the arithmetic unit 310 causes the display unit 402 as a first display means to display the information in real time, the countermeasure for eliminating (clearing) the jam on the operation display unit 122. The countermeasure is displayed on the operation display unit 122, so that it is possible to prompt the user to remove the jammed sheet S, for example.

Further, the server 300 as the information processing apparatus communicatable with the image forming apparatus 100 includes the cause discriminating means and the display discriminating means, and may discriminate whether or not information on the cause is displayed, on the basis of an occurrence rate which is the number of times of the conveyance failure occurred per unit time. The server 300 may function as the apparatus management system and may also function as a part of the apparatus management system as described above.

As described above, according to the embodiment 1, for the jam occurred in the image forming apparatus, by specifying the cause with high possibility, at an appropriate timing before the service call is made, the countermeasure against the cause of the jam can be notified to the user or the dealer performing the maintenance management.

### Embodiment 2

In the embodiment 1, an example in which the cause discriminating unit discriminates the cause (mixed loading) of a single jam was described, but in an embodiment 2, an instance in which the jam cause is discriminated by each of a plurality of cause discriminating units will be described. Portions overlapping with description of the embodiment 1 will be omitted from description by adding the same reference numerals or symbols.

### Flow for Discriminating Cause of Jam From Information Acquired From Image Forming Apparatus 100 by Plurality of Cause Discriminating Units

In the embodiment 2, a constitution in which the cause discriminating unit is capable of specifying, as the cause of the jam, in addition to the “mixed loading” specified in the embodiment 1, that the jam occurs due to an end of a roller lifetime (roller lifetime-end) of the feed roller 12 and the separation roller 13 is employed. In the embodiment 2, the apparatus management system includes two cause discriminating units, i.e., a cause discriminating unit for the mixed loading as a first cause discriminating means and a cause discriminating unit for the roller lifetime-end as a second cause discriminating means.

Description of the case where the jam occurs due to the roller lifetime-end will be described. When a total number of printed sheets increases (when the printing advances), abrasion of surfaces of the feed roller 12 and the separation roller 13 progresses, so that a conveying force lowers. Then, a slip occurs between the conveyed sheet S and each of the feed roller 12 and the separation roller 13, and it becomes hard to convey the sheet S by a predetermined distance, so that the jam occurs. The engine controller 110 manages the total number of printed sheets, a total number of rotations, a total traveling distance, and the like of the feed roller 12 and the separation roller 13 from a new article state of the feed roller 12 and the separation roller 13, and on the basis of these parameters, the engine controller 110 discriminates the roller lifetime (end).

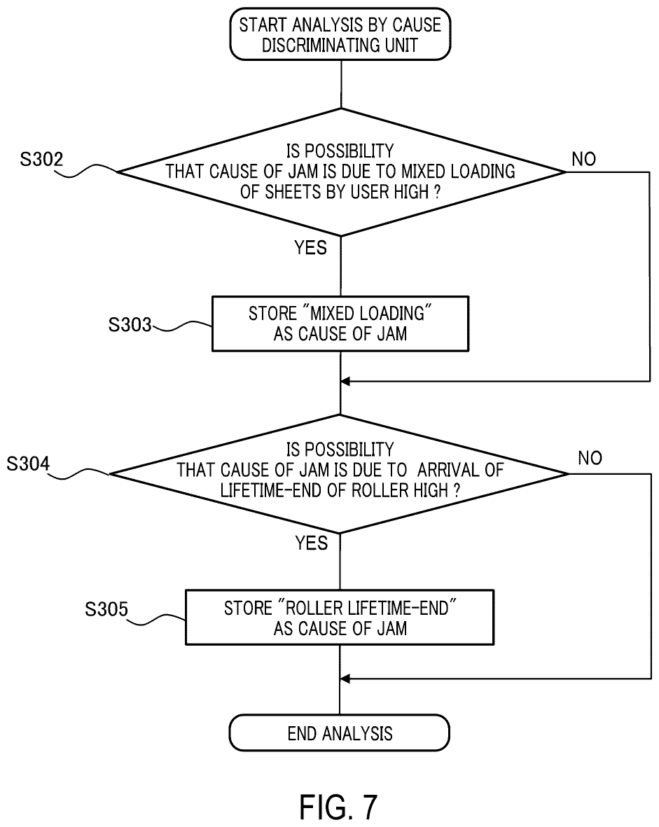

Also, in the embodiment 2, the processing of FIG. 3 is executed. When the analysis by the cause discriminating unit is started in S504 shown in FIG. 3, the cause discriminating unit starts processing of FIG. 7. In S302, the cause discriminating unit for the mixed loading discriminates whether or not a possibility that the cause of the jam is due to the mixed loading of the sheets S is high. As shown in FIG. 7, first, similarly as the embodiment 1, the analysis as to whether or not the cause of the jam is due to that the sheets S is loaded in mixture is conducted by the cause discriminating unit for the mixed loading. In S302, in the case where the cause discriminating unit for the mixed loading discriminated that “the possibility that the cause of the jam is due to the mixed loading is high”, the cause discriminating unit causes the processing to go to S303.

Here, the cause discriminating unit for the mixed loading discriminates that the cause of the jam is due to the mixed loading is high in the case where the change amount in mixed loading index value X and mixed loading index value Y is the threshold or less as described with reference to FIG. 4.

In S303, the cause discriminating unit for the mixed loading stores the “mixed loading” as the cause of the jam in a storing unit (portion). In S302, in the case where the cause discriminating unit for the mixed loading discriminated that “the possibility that the cause of the jam is due to the mixed loading is low”, the cause discriminating unit causes the processing to go to S304. Here, the cause discriminating unit for the mixed loading discriminates that the cause of the jam is due to the mixed loading is low in the case where the change amount in mixed loading index value X and mixed loading index value Y is the threshold or less as described with reference to FIG. 4.

In S304, the cause discriminating unit for the roller lifetime-end discriminates whether or not possibility that the cause of the jam is due to that the feed roller 12 and the separation roller 13 arrive at their ends of lifetimes is high. In S304, in the case where the cause discriminating unit for the roller lifetime-end discriminated that “possibility that the cause of the jam is due to the roller lifetime end is high”, the cause discriminating unit for the roller lifetime-end causes the processing to go to S305. In S305, the cause discriminating unit for the roller lifetime-end stores the “roller lifetime-end” as the cause of the jam in the storing unit, and then ends the processing. In S304, the cause discriminating unit for the roller lifetime-end discriminated that possibility that the cause of the jam is due to the roller lifetime-end is low, the cause discriminating unit ends the processing.

For example, the cause discriminating unit for the roller lifetime-end discriminates that the possibility that the jam cause is the roller lifetime-end is high in the case where the above-described number of printed sheets, number of rotations, traveling distance, and the like are more than the predetermined thresholds, and discriminates that the possibility that the jam cause is the roller lifetime-end is low in the case where the above-described parameters are the predetermined thresholds or less. Incidentally, the predetermined thresholds can be set to maximum values or the like at which the feed roller 12 and the separation roller 13 can convey the sheet without generating the slip or the like.

By this, the cause discriminating unit finally stores the “mixed loading” and the “roller lifetime-end” as the jam cause, so that the analysis by the cause discriminating unit ends.

### Flow in Which Cause Selecting Unit Selects Cause With High Possibility From Causes Discriminated by Cause Discriminating Unit

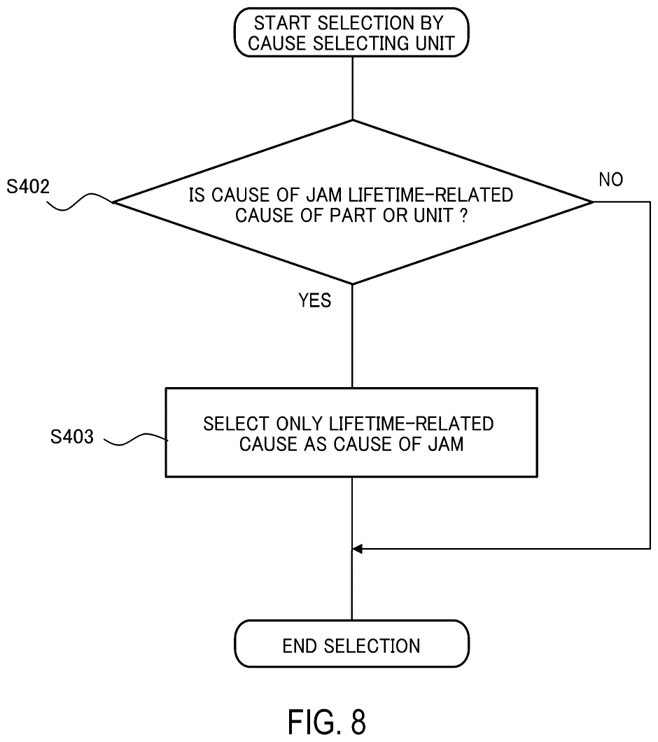

Next, in the analysis of S504 of FIG. 3, a flow in which a cause selecting unit (portion) as a selecting means selects the cause of the cause with high possibility from causes discriminated by the cause discriminating unit will be described using FIG. 8. In the analysis by the cause discriminating unit in S504 shown in FIG. 3, in the case where there are a plurality of the cause discriminating units, after the above-described analysis by the plurality of the cause discriminating units in FIG. 7, selection by the cause selecting unit is made.

As shown in FIG. 8, when the selection by the cause selecting unit is started, the cause selecting unit discriminates in S402 whether or not the cause of the jam relates to a lifetime (-end) of a part or a unit. In S402, in the case where the cause selecting unit discriminates that the cause of the jam is a lifetime-related cause of the part or the unit, the cause selecting unit causes the processing to go to S403. For example, after the processing of FIG. 7, when information of the “mixed loading” and the “roller lifetime-end” or of only the “roller lifetime-end” is stored in the storing unit, the cause selecting unit causes the processing to go to S403.

In S403, the cause selecting unit selects only the L-related cause as the cause of the jam and then ends the selection (processing). In the embodiment 2, of the “roller lifetime-end” and the “mixed loading” stored in the storing unit by the cause discriminating unit, the “roller lifetime-end” is the lifetime-related cause of the part or the unit.

Therefore, the cause selecting unit selects only the “roller lifetime-end” and then ends the processing. In S402, in the case where the cause selecting unit discriminated that the cause of the jam is not the lifetime-related cause of the part or the unit, the cause selecting unit ends the processing. For example, after the processing of FIG. 7, when the information of only the “mixed loading” is stored in the storing unit or not information is stored in the storing unit, the cause selecting unit ends the processing. The arithmetic unit 310 of the server 300 functions as the above-described cause discriminating unit and the above-described display discriminating unit. Further, the arithmetic unit 310 of the server 300 functions as the cause selecting unit, and the storing device 320 functions as the storing unit.

After the end of the selection by the cause selecting unit in FIG. 8, similarly as the embodiment 1, in the case where discrimination that the information based on the cause of the jam is notified by the display discriminating unit shown in FIG. 3 (S505), the processing goes to S506. In S506, the display discriminating unit causes the display unit 402 of the maintenance management computer 400 to display and notify the jam cause selected by the cause selecting unit and the countermeasure based on the jam cause. In the embodiment 2, messages to the effect that the cause of the jam is the roller lifetime-end and to the effect that exchange of the feed roller 12 and the separation roller 13 are displayed and notifies on the display unit 402.

### Reason Why Lifetime-Related Cause is Prioritized

Here, in the case where the cause of the jam relates to the lifetime(-end) of the part or the unit, a reason why the lifetime-related cause is prioritized and selected will be described. In the case where a possibility that the jam cause is the lifetime-related cause is high, the cause is notified and addressed early, so that it is possible to prevent erroneous discrimination of the jam cause. In the case where the lifetime-related cause is the jam cause, for example, in the case where the roller lifetime-end is the cause of the jam, by uneven abrasion of the roller, a conveyance property of the sheet S becomes unstable, so that a phenomenon such that a variation in conveyance data of the sheet S becomes large occurs. When the analysis of S504 is executed by data in a state in which a conveyance variation of the sheet S is large, i.e., by unintended data, a possibility that the cause of the jam is erroneously discriminated becomes high. In order to eliminate this possibility, in the embodiment 2, the lifetime-based cause is prioritized and selected, and notification is provided to the display unit 402 so as to eliminate the lifetime-based cause early.

As described above, in the embodiment 2, when the jam or the like occurred in the image forming apparatus 100, the cause with high possibility is selected from the plurality of causes. Then, at an appropriate timing when the service call is made, it becomes possible to notify the countermeasure against the cause of the jam to the user or the dealer performing maintenance management.

Incidentally, in the embodiment 2, in order to prevent erroneous discrimination of the cause of the jam, the information based on the cause of the jam relating to the lifetime-end of the part or the unit was prioritized and notified to the display unit 402, but the present invention is not limited thereto. The display discriminating unit may prioritize and notify, to the display unit 402, the cause of the jam such as cause due to the user, for example, the mixed loading or a set error of a width regulating plate for the sheets S provided in the sheet accommodating portion. This has an effect such that a jam occurrence frequency can be suppressed until the dealer performing the maintenance management is dispatched by early notifying the cause simply addressable by the user through a remote instruction since it takes time until the dealer performing the maintenance management is dispatched.

Further, in the embodiment 2, the cause selecting unit selects the cause of the jam and notifies the selected cause, but the present invention is not limited thereto. In the case where a plurality of causes are specified by the plurality of cause discriminating units, all the causes may be displayed on and notified to the display unit 402 without being selected by the cause selecting unit. This has an effect such that the plurality of jam causes can be eliminated by one dispatch.

Further, when the display discriminating unit causes the display unit 402 to display a plurality of pieces of information based on the jam, for the purpose of clarifying an order of instruction to the dealer performing the maintenance management, these pieces of the information may be displayed and notified by being arranged in an increasing possibility order.

Further, for the purpose of accurately providing an instruction to the dealer performing the maintenance management, the display discriminating unit may cause the display unit 402 to display only one information with high possibility.

Further, for the purpose of improving operation efficiency of the dealer performing the maintenance management, the display discriminating unit may cause the display unit 402 to display and notify the pieces of information in an order that the dealer performing the maintenance management is easier to address the cause.

Further, for specifying the jam cause with high possibility, the cause discriminating unit may specify the cause by checking the information against not only the information acquired from the image forming apparatus 100 but also post service information of the dealer performing the maintenance management or the like.

As described above, according to the embodiment 2, for the jam occurred in the image forming apparatus, by specifying the cause with high possibility, at an appropriate timing before the service call is made, the countermeasure against the cause of the jam can be notified to the user or the dealer performing the maintenance management.

### Embodiment 3

In the embodiment 1, an example in which the analysis was conducted in the server and in which a result thereof was displayed on and notified to the display unit 402 was shown. In an embodiment 3, an instance in which the analysis is conducted as needed in the image forming apparatus 100 and in which when the jam occurred, a jam eliminating (clearing) method, and in addition, a result thereof are displayed on the operation display unit 122 as a display means in the image forming apparatus 100 will be described. Here, the “jam eliminating method” refers to a method for removing the sheet S jammed and at rest on the conveying path to an outside of the image forming apparatus 100. Portions overlapping with description of the embodiment 1 will be omitted from description by adding the same reference numerals or symbols.

### Flow for Discriminating Cause of Jam From Information Acquired From Image Forming Apparatus 100 by Cause Discriminating Unit

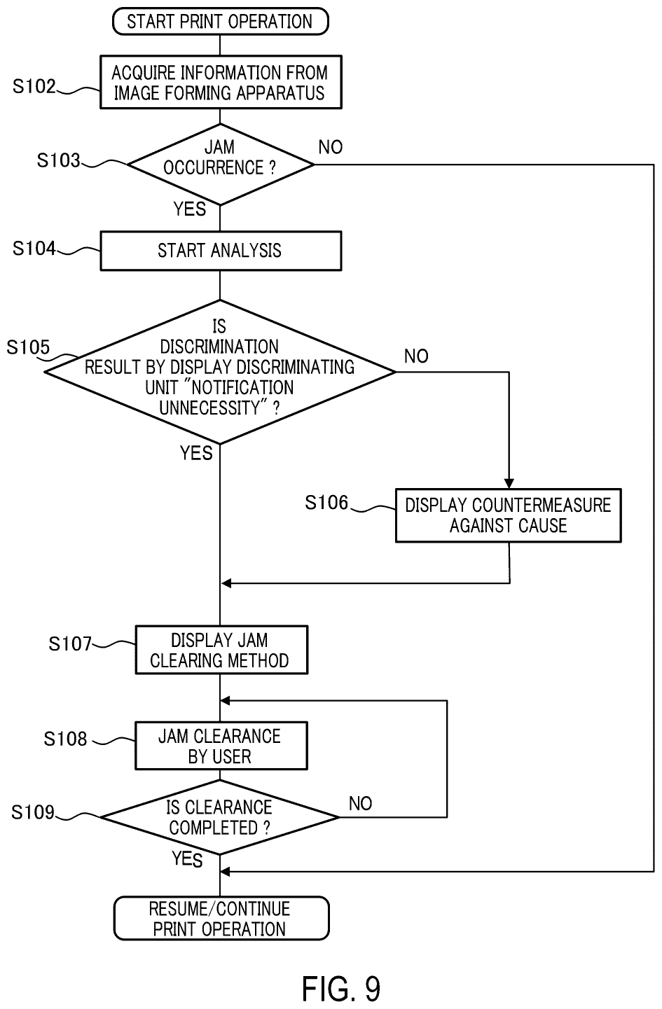

As shown in FIG. 9, when a print operation of the image forming apparatus 100 is started, processing of S102 and later is started. In S102, the cause discriminating unit acquires information from the image forming apparatus 100. In S103, the cause discriminating unit discriminates whether or not the jam occurred once or more during the printing. In the case where the cause discriminating unit discriminated in S103 that the jam occurred once or more, the cause discriminating unit causes the processing to go to S104. In S104, the cause discriminating unit starts the analysis. In the embodiment 3, the CPU 111 in the image forming apparatus 100 starts the analysis. That is, the CPU 111 functions as the cause discriminating unit. For example, similarly as in the embodiment 1, the CPU 111 discriminates that the cause of the jam is the mixed loading.

In S105, the display discriminating unit discriminates whether or not notification of information based on the cause of the jam is unnecessary. In the case where the display discriminating unit discriminated in S105 that the notification is necessary, the display discriminating unit causes the processing to go to S106. In the case where the display discriminating unit discriminated in S105 that the notification in unnecessary, the display discriminating unit causes the processing to go to S107.

In S106, the display discriminating unit causes the operation display unit 122 in the image forming apparatus 100 to display and notify the jam cause specified in S104 and a countermeasure based on the cause and then causes the processing to go to S107. The cause of the jam is notified to the operation display unit 122 in the image forming apparatus 100. For this reason, in the case where the cause was the mixed loading or was due to a user operation such as a set error of a width regulating plate for the sheets provided in the sheet accommodating portion the cause is eliminated by a user himself (herself), whereby occurrence of a subsequent jam and later jams can be eliminated.

Thereafter, the cause of the jam and the countermeasure based on the cause are displayed on the operation display unit 122, and in addition, in S107, a jam clearing (eliminating) method is displayed on the operation display unit 122. In the jam cleaning method, occurrence position information of the jam in the image forming apparatus 100 and unit mounting/demounting operation information necessary for clearing the jam, and the like information are included. In the embodiment 3, the CPU 111 functions as the display discriminating unit.

In S108, jam clearance by the user is performed. In S109, the image forming apparatus 100 discriminates that the jammed sheet does not remain in the image forming apparatus 100 and that the unit operated by the user for clearing the jam is normally mounted or the like, and thus discriminates whether or not the jam clearance is completed. In the case where the image forming apparatus 100 discriminated in S109 that the jam clearance is completed, the image forming apparatus 100 resumes the print operation. In the case where the image forming apparatus 100 discriminated in S109 that the jam clearance is not completed, the image forming apparatus 100 causes the processing to return to S108.

As described above, in the embodiment 3, in the case where the jam frequently occurred in the image forming apparatus 100, it becomes possible that the cause with high possibility is specified and the countermeasure against the cause is notified immediately to the user. For example, in the case where the cause of the jam is the mixed loading, the user eliminates the mixed loading state in accordance with a countermeasure such that “It is recommended that sheets all of which are the same kind are stacked in the sheet accommodating portion” displayed on the operation display unit 122 in the image forming apparatus 100. By this, it becomes possible to eliminate the cause of the jam by the user himself (herself). Before the service call is made, the cause of the jam and the countermeasure based on the cause can be notified to the user, and therefore, service dispatch of the dealer performing the maintenance management can be suppressed, so that a service cost can be remarkably suppressed.

Incidentally, the image forming apparatus 100 may perform the processing of FIG. 7 and FIG. 8 in the embodiment 2.

As described above, according to the embodiment 3, for the jam occurred in the image forming apparatus, by specifying the cause with high possibility, at an appropriate timing before the service call is made, the countermeasure against the cause of the jam can be notified to the user or the dealer performing the maintenance management.

### Other Embodiments

The present invention can also be realized by processing in which a program for realizing one or more functions in the above-described embodiments is supplied to a system or an apparatus via a network or a storing medium and in which one or more processors in a computer of the system or the apparatus reads and executes the program. Further, the present invention can also be realized by a circuit (for example, ASIC) for realizing one or more function.

According to the present invention, for the jam occurred in the image forming apparatus, by specifying the cause with high possibility, at an appropriate timing before the service call is made, the countermeasure against the cause of the jam can be notified to the user or the dealer performing the maintenance management.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-066108 filed on Apr. 16, 2024, which is hereby incorporated by reference herein in its entirety.

What is claimed is:

1. An apparatus management system for managing an image forming apparatus, comprising:
a detecting unit configured to detect conveyance failure of a recording material in the image forming apparatus;
at least one cause discriminating unit configured to discriminate a cause of the conveyance failure, detected by the detecting unit, on the basis of information acquired from the image forming apparatus;
a display unit configured to display information on the cause discriminated by the cause discriminating unit; and
a display discriminating unit configured to discriminate whether or not the information on the cause is displayed on the display unit,
wherein the display discriminating unit discriminating whether or not the information on the cause is displayed on the display unit, on the basis of a first occurrence rate which is a number of times of the conveyance failure occurred per unit time and a second occurrence rate which is a number of times of the conveyance failure per number of printed sheets.

2. An apparatus management system according to claim 1, wherein the at least one cause discriminating unit comprises a plurality of cause discriminating units, and
wherein the apparatus management system further comprises a selecting unit configured to select at least one cause from a plurality of causes of the conveyance failure discriminated by the plurality of cause discriminating units, respectively.

3. An apparatus management system according to claim 2, wherein one of the plurality of cause discriminating units discriminates that a lifetime of a part or a unit included in the image forming apparatus is the cause, and
wherein in a case where the one of the plurality of cause discriminating units discriminates that the lifetime of the part or the unit is the cause, the selecting unit selects, as the cause, the lifetime of the part or the unit.

4. An apparatus management system according to claim 2, wherein one of the plurality of cause discriminating units discriminates that the cause is due to a user, and
wherein in a case where the one of the plurality of cause discriminating units discriminates that the cause is due to the user, the selecting unit selects, as the cause, that the cause is due to the user.

5. An apparatus management system according to claim 1, wherein the at least one cause discriminating unit comprises a plurality of cause discriminating units, and
wherein the display discriminating unit causes the display unit to display all of information on a plurality of causes of the conveyance failure discriminated by the plurality of cause discriminating units, respectively.

6. An apparatus management system according to claim 1, wherein the image forming apparatus includes an image forming unit configured to form an image on the recording material, a conveying unit configured to convey the recording material, a driving unit configured to drive the conveying unit, a sound collecting unit, and an environment detecting unit configured to detect a temperature or a humidity, and
wherein the information acquired from the image forming apparatus includes at least one of conveyance information of the recording material conveyed by the conveying unit, information of the driving unit, information on a sound collected by the sound collecting unit, operation information of the image forming unit, information detected by the environment detecting unit, and print information.

7. An apparatus management system according to claim 1, wherein in a case where the first occurrence rate is a first threshold or more or in a case where the first occurrence rate is less than the first threshold and a second occurrence rate is a second threshold or more, the display discriminating unit determines that the information on the cause is displayed on the display unit.

8. An apparatus management system according to claim 1, further comprising:
a server connected to the image forming apparatus and including the cause discriminating unit and the display discriminating unit; and
a monitoring tool including the display portion and capable of making reference to information of the server.

9. An apparatus management system according to claim 1, further comprising a computer connected to the image forming apparatus.

10. An apparatus management system according to claim 1, wherein the image forming apparatus includes the display unit.

11. An apparatus management system according to claim 1, wherein when the display unit is a first display unit,
the image forming apparatus includes a second display unit, and
in a case where the display discriminating unit discriminates that the display discriminating unit causes the display unit to make display, the display discriminating unit causes the second display unit to display a processing method for removing the recording material causing the conveyance failure to an outside of the image forming apparatus and causes the first display unit to display the information on the cause.

12. An apparatus management system according to claim 1, wherein the information on the cause is the cause of the conveyance failure discriminated by the cause discriminating unit and/or a processing method for eliminating the cause of the conveyance failure.

13. An image forming apparatus for forming an image on a recording material, comprising:
a detecting unit configured to detect conveyance failure of the recording material;
at least one cause discriminating unit configured to discriminate a cause of the conveyance failure detected by the detecting unit;
a display unit configured to display information on the cause discriminated by the cause discriminating unit; and
a display discriminating unit configured to discriminate whether or not the information on the cause is displayed on the display unit,
wherein the display discriminating unit discriminating whether or not the information on the cause is displayed on the display unit, on the basis of a first occurrence rate which is a number of times of the conveyance failure occurred per unit time and a second occurrence rate which is a number of times of the conveyance failure per number of printed sheets.

14. An image forming apparatus according to claim 13, wherein the at least one cause discriminating unit comprises a plurality of cause discriminating units, and
wherein the apparatus management system further comprises a selecting unit configured to select at least one cause from a plurality of causes of the conveyance failure discriminated by the plurality of cause discriminating units, respectively.

15. An image forming apparatus according to claim 14, wherein one of the plurality of cause discriminating units discriminates that a lifetime of a part or a unit included in the image forming apparatus is the cause, and
wherein in a case where the one of the plurality of cause discriminating units discriminates that the lifetime of the part or the unit is the cause, the selecting unit selects, as the cause, the lifetime of the part or the unit.

16. An image forming apparatus according to claim 14, wherein one of the plurality of cause discriminating units discriminates that the cause is due to a user, and
wherein in a case where the one of the plurality of cause discriminating units discriminates that the cause is due to the user, the selecting unit selects, as the cause, that the cause is due to the user.

17. An image forming apparatus according to claim 13, wherein the at least one cause discriminating unit comprises a plurality of cause discriminating units, and
wherein the display discriminating unit causes the display unit to display all of information on a plurality of causes of the conveyance failure discriminated by the plurality of cause discriminating units, respectively.

18. An image forming apparatus according to claim 13, further comprising:
an image forming unit configured to form an image on the recording material;
a conveying unit configured to convey the recording material;
a driving unit configured to drive the conveying unit;
a sound collecting unit; and
an environment detecting unit configured to detect a temperature or a humidity, and
wherein the cause discriminating unit discriminates the cause of the conveyance failure on the basis of at least one of conveyance information of the recording material conveyed by the conveying unit, information on a sound collected by the sound collecting unit, operation information of the image forming unit, information detected by the environment detecting unit, and print information.

19. An image forming apparatus according to claim 13, wherein in a case where the first occurrence rate is a first threshold or more or in a case where the first occurrence rate is less than the first threshold and a second occurrence rate is a second threshold or more, the display discriminating unit determines that the information on the cause is displayed on the display unit.

20. An information processing apparatus capable of communicating with an image forming apparatus, comprising:
a cause discriminating unit configured to discriminate a cause of conveyance failure in the image forming apparatus on the basis of information acquired from the image forming apparatus; and
a display discriminating unit configured to discriminate whether or not information on the cause is displayed on a display unit,
wherein the display discriminating unit discriminating whether or not the information on the cause is displayed on the display unit, on the basis of a first occurrence rate which is a number of times of the conveyance failure occurred per unit time and a second occurrence rate which is a number of times of the conveyance failure per number of printed sheets.
